(19) United States
(12) Patent Application Publication
(10) Pub. No.: US 2007/0199905 A1
(43) Pub. Date: Aug. 30, 2007

(54) METHOD FOR SLUSHING AND CLEANING PAPER RAW MATERIALS CONTAINING CONTAMINANTS

(75) Inventor: Michael PIPER, Appleton, WI (US)

Correspondence Address: GREENBLUM & BERNSTEIN, P.L.C., 1950 ROLAND CLARKE PLACE, RESTON, VA, 20191, US

(73) Assignee: VOITH PATENT GmbH, Heidenheim (DE)

(21) Appl. No.: 11/677,744

(22) Filed: Feb. 22, 2007

(30) Foreign Application Priority Data
Feb. 24, 2006 (DE) 2006 008 761.5

(51) Int. Cl. C02F 1/00

(52) U.S. Cl. 210/767

(57) ABSTRACT

A method and system provides slushing and cleaning of paper raw materials containing contaminants, in particular of recovered paper. These raw materials are introduced, e.g., into a pulper and mixed with water. An accepted stock is drawn off through a pulper screen, and a partial flow from the pulper reaches a settling container and then a closed screen apparatus with the aid of a pump apparatus. A recirculation flow is recirculated from the pressure line of the pump apparatus into the settling container. This mode of operation increases the operational safety of the slushing system and evens out the stock flows.

### CROSS-REFERENCE TO RELATED APPLICATIONS

The present application claims priority under 35 U.S.C. §119 of German Patent Application No. 10 2006 008 761.5, filed on Feb. 24, 2006, the disclosure of which is expressly incorporated by reference herein in its entirety.

### BACKGROUND OF THE INVENTION

1. Field of the Invention

The invention relates to a method for suspending and cleaning paper raw materials containing contaminants, and in particular from recovered paper.

2. Discussion of Background Information

Paper raw materials are used on a large scale for paper production. As is known, though, paper raw materials contain some proportion of contaminants. Contaminants are predominantly plastic parts and plastic sheets, wires, broken glass, sand, etc. Naturally, the contaminants are removed as completely as possible to protect the machines used for processing the raw materials and to meet the quality requirements for the future paper.

Methods have proven successful in which the paper raw material is first slushed in a pulper, e.g., with a dry matter content between 4 and 8%, by breaking up the paper raw material through mechanical processing after having mixed it with water, whereby a large part of the contaminants remains firm. For example, plastic sheets retain a relatively large surface, and the paper webs can be broken up into individual fibers or fiber bundles. The largest contaminants are often removed directly from the pulper, e.g., in a ragger.

During slushing, a suspension is produced which contains a relatively high proportion of contaminants. These suspensions can generally be pumped or discharged from the slusher. In a method of this type, e.g., according to DE 102004015011, a highly contaminated stock flow is discharged directly out of the slusher, whereas a less contaminated stock flow is pumped out through a screen inserted in the slusher as accepted stock.

A screen apparatus downstream of the slushing apparatus receives a highly polluted suspension. Fiber components no longer containing any coarse contaminants can be drawn off as accepted stock fraction through the screen present in the screen apparatus. As a rule, further cleaning processes are also required for this accepted stock, until a paper can be produced therefrom.

### SUMMARY OF THE INVENTION

The invention is based on creating a method that renders it possible to treat even paper raw materials with a high content of contaminants in an economical and operationally safe manner. This is attained through a recirculation flow recirculated into a settling apparatus from a pressure line of a pump apparatus.

In aspects of the invention, a method is provided for suspending and cleaning paper raw materials containing contaminants, in particular recovered paper. The paper raw material is mixed with water and slushed into a suspension containing contaminants. An unscreened partial flow of this suspension is guided into a settling apparatus and then into a closed screen apparatus with the aid of a pump apparatus. In the screen apparatus the partial flow is screened with a screen, through which an accepted stock flow is guided, and through which the contaminants retained at the screen accumulate in the screen apparatus. The contaminants are discharged from the screen apparatus continuously or at adjustable intervals and guided to a screening device. A recirculation flow recirculated of the unscreened partial flow into a settling apparatus from a pressure line of the pump apparatus.

The method further includes carrying out slushing in a pulper. An accepted stock is continuously drawn off from the pulper through a pulper screen. The partial flow is not drawn off through the pulper screen allotted to the accepted stock. The partial flow is coarser in its solid material composition than the accepted stock drawn off from the pulper. A screen apparatus with flat screen is used, which is kept clear by a central rotor. The contaminants retained at the screen of the screen apparatus are removed at intervals from the screen apparatus as reject. The reject is rinsed out by the surge-like addition of water into the screen apparatus. The recirculation flow is divided off from the pressure line at a point that is a maximum of 2 m, preferably a maximum of 1 m from the infeed into the screen apparatus. The screen apparatus is operated with perpendicular axis and the accepted stock chamber is arranged above the screen. The line between the reject outflow on the screen apparatus and the screening device does not contain any pressure-increasing apparatuses. The screening device is at least about 3 m higher than the screen apparatus.

A method for suspending and cleaning paper raw materials containing contaminants, comprising mixing paper raw material with water and slushing into a suspension. The method further includes screening a partial flow of the suspension to accumulate contaminants, discharging the contaminants from the suspension continuously or at adjustable intervals, and recirculating a recirculation flow of the partial flow into a settling apparatus from a pressure line of a pump apparatus.

In further aspects, the method comprises continuously drawing off an accepted stock. The partial flow is coarser in its solid material composition than the accepted stock drawn. The recirculation flow is divided off from the pressure line at a point that is a maximum of about 2 m from an infeed into a screen apparatus. The recirculation flow is divided off from the pressure line at a point that is a maximum of 1 m from an infeed into a screen apparatus.

A system for suspending and cleaning paper raw materials containing contaminants, comprises a pulper which is configured to mix paper raw material with water and slush into a suspension containing the contaminants. The system further comprises a settling tank configured to receive an unscreened partial flow of the suspension from the pulper and a pump apparatus. A screen apparatus comprises a retaining area configured to retain the contaminants accumulated therein, a screen configured to screen the partial flow of the suspension, and a discharge area configured to discharge the contaminants from the screen apparatus continuously or at adjustable intervals. The pump apparatus is configured to pump the unscreened partial flow of the suspension into the screen apparatus and recirculate a recirculation flow of the unscreened partial flow into the settling apparatus from a pressure line of the pump apparatus.

The screen is a flat screen which is kept clear by a central rotor. The recirculation flow is divided off from the pressure line at a point that is a maximum of about 2 m from an infeed into the screen apparatus. The recirculation flow is divided off from the pressure line at a point that is a maximum of 1 m from the infeed into the screen apparatus. The screen apparatus is operated with a perpendicular axis and an accepted stock chamber is arranged above the screen. A screening device is at least about 3 m higher than the screen apparatus.

### BRIEF DESCRIPTION OF THE DRAWINGS

The present invention is further described in the detailed description which follows, in reference to the noted drawing by way of non-limiting examples of exemplary embodiments of the present invention, in which the drawing shows a diagram of an installation suitable for the method of the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawing making apparent to those skilled in the art how the several forms of the present invention may be embodied in practice.

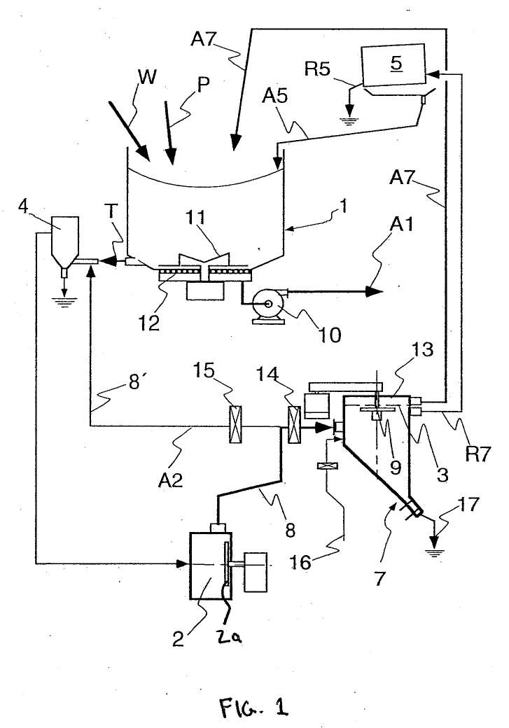

FIG. 1 shows a pulper 1, into which paper raw material P, in particular recovered paper, and water W is poured. The paper raw material P is mixed with the water W and, with a dry matter content of approximately 4 to 8%, processed mechanically by a rotor 11 and slushed into a suspension. The predominant part of the generated suspension is continuously pumped out as accepted stock A1, via a pump 10, through a pulper screen 12 inserted in the base of the pulper 1.

Another coarser and highly polluted part leaves the pulper as partial flow T, bypassing the pulper screen 12 and arriving in a settling apparatus 4 for separating the coarsest heavy contaminants. Gravity is sufficient as a separation force, but an intensification through centrifugal forces (e.g., rotational flow) can also be used with the present invention.

The suspension enters a central infeed of a pump apparatus 2 that is suitable for pumping highly contaminated suspension. Advantageously, the pump apparatus 2 further slushes the paper. In embodiments, the pump apparatus 2 can have a cylindrical or conical housing with an impeller rotor 2a that brings about both the pressure increase and a continuation of the slushing. A pressure line 8 joins the housing of the pump apparatus 2, in a tangential manner.

According to the invention, a part of the suspension flowing in the pressure line 8 is recirculated as recirculation flow A2 into the partial flow T drawn off from the pulper 1. The recirculation flow A2 reaches the settling apparatus 4 through a return line 8′ and then goes into the pump apparatus 2. In embodiments, the recirculation flow A2 is divided off from the pressure line 8 at a point that is a maximum of 2 m, preferably a maximum of 1 m from the infeed into a screen apparatus 7. The pump apparatus 2 has the particular advantage that the slushing effect of the pump apparatus 2 can be utilized again. The separating effect of the settling apparatus 4 can also have an impact, again, by extracting further heavy contaminants released. Among other things, this reduces wear on the downstream apparatuses.

The recirculation flow A2 is particularly advantageous if the contaminants R7 are drawn off from the screen apparatus 7 (described later) at intervals. More specifically, the contaminants R7 are drawn off from the screen apparatus 7 during the rinsing process, i.e., as long as the screen apparatus 7 cannot receive any suspension from the pump apparatus 2. In this manner, the recirculation flow A2 can be used in the circulation with both a settling apparatus 4 and pump apparatus 2 to continue the slushing and to remove further heavy contaminants.

It is favorable to place the branch of the return line 8′ that is to receive the recirculation flow A2 as close as possible to the infeed fitting to the screen apparatus 7. In operation, this reduces the danger of clogging the feed line to the screen apparatus 7, which is caused by the stock flow being interrupted from time to time. Furthermore, a large buffer volume is created in the corresponding return line 8′ to receive the recirculation flow A2.

The screen apparatus 7 comprises a closed, e.g., partly cylindrical, partly conical housing. Heavy contaminants 17 can sink down to the bottom area of the housing and can be extracted. The screen apparatus 7 contains a screen 3, embodied as a flat screen, which is kept clear of clogging by a rotor 9. It should be understood that other types of screens 3 are also contemplated by the invention. The suspension that has passed through the screen 3 collects in an accepted stock chamber 13 located above the screen 3 and is drained off as accepted stock A7, preferably into the pulper 1.

In addition, the contaminants retained at the screen 3 accumulate inside the screen apparatus 7. These contaminants are discharged as reject R7 continuously or at certain intervals into a screening device 5 that generates a dirt fraction R5 and an accepted stock fraction A5. The preferred rinsing at intervals has the advantage of a complete or at least better removal of the contaminants from the screen apparatus 7. The removal can be intensified or accelerated by the surge-like addition of water 16 into the screen apparatus 7. The amount of the recirculation flow A2 can be regulated by valves 14 and 15, and optionally in a program-controlled manner if the rinsing of the screen apparatus 7 takes place periodically.

The screen apparatus 7 can also have a horizontal axis. For example, the screen apparatus 7 can be e.g., a secondary pulper, like or similar to the screen apparatus shown in DE 102004015011.

A pivotable screen drum acts as a screening device 5, but other correspondingly suitable apparatuses are also contemplated by the invention. The connection between the reject outflow 6 of the screen apparatus 7 and the screening device 5 advantageously does not have any further pressure-increasing apparatuses. This saves energy and equipment-related expenditure.

It should be understood by those of skill in the art that the drawing should not be understood to reveal proportions and positions of the apparatuses used. Individual details, however, correspond to favorable technical embodiments. Thus it is advantageous to arrange, e.g., the screening device 5 is above the pulper 1, as the accepted stock A5 thus formed in the screening device 5 can flow back freely into the container of the pulper 1. Additionally, the screening device 5 is at least about 3 m higher than the screen apparatus 7.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for suspending and cleaning paper raw materials containing contaminants, in recovered paper, comprising:
mixing paper raw material with water and slushing into a suspension containing the contaminants;
guiding an unscreened partial flow of the suspension into a settling apparatus and into a closed screen apparatus with aid of a pump apparatus;
screening the partial flow with a screen, comprising:
guiding an accepted stock flow, and
accumulating the contaminants retained at the screen in the screen apparatus,
discharging the contaminants from the screen apparatus continuously or at adjustable intervals, and
guiding the discharge to a screening device; and
recirculating a recirculation flow of the unscreened partial flow into the settling apparatus from a pressure line of the pump apparatus.

2. The method according to claim 1, wherein the slushing is carried out in a pulper.

3. The method according to claim 2, further comprising continuously drawing off an accepted stock from the pulper through a pulper screen.

4. The method according to claim 3, wherein the partial flow is not drawn off through the pulper screen allotted to the accepted stock.

5. The method according to claim 3, wherein the partial flow is coarser in its solid material composition than the accepted stock drawn off from the pulper.

6. The method according to claim 1, wherein the screen is a flat screen which is kept clear by a central rotor.

7. The method according to claim 1, wherein the contaminants retained at the screen are removed at intervals from the screen apparatus as reject.

8. The method according to claim 7, wherein the reject is rinsed by addition of water into the screen apparatus.

9. The method according to claim 1, wherein the recirculation flow is divided off from the pressure line at a point that is a maximum of about 2 m from an infeed into the screen apparatus.

10. The method according to claim 1, wherein the recirculation flow is divided off from the pressure line at a point that is a maximum of 1 m from the infeed into the screen apparatus.

11. The method according to claim 1, wherein the screen apparatus is operated with a perpendicular axis and the accepted stock chamber is arranged above the screen.

12. The method according to claim 1, wherein a line between a reject outflow on the screen apparatus and the screening device does not contain any pressure-increasing apparatuses.

13. The method according to claim 1, wherein the screening device is at least about 3 m higher than the screen apparatus.

14. A method for suspending and cleaning paper raw materials containing contaminants, comprising:
mixing paper raw material with water and slushing into a suspension;
screening a partial flow of the suspension to accumulate contaminants;
discharging the contaminants from the suspension continuously or at adjustable intervals, and
recirculating a recirculation flow of the partial flow into a settling apparatus from a pressure line of a pump apparatus.

15. The method according to claim 14, further comprising continuously drawing off an accepted stock.

16. The method according to claim 15, wherein the partial flow is coarser in its solid material composition than the accepted stock drawn.

17. The method according to claim 14, wherein:
the recirculation flow is divided off from the pressure line at a point that is a maximum of about 2 m from an infeed into a screen apparatus; and.

18. The method according to claim 14, wherein:
the recirculation flow is divided off from the pressure line at a point that is a maximum of 1 m from an infeed into a screen apparatus.

19. A system for suspending and cleaning paper raw materials containing contaminants, comprising:
a pulper configured to mix paper raw material with water and slush into a suspension containing the contaminants;
a settling tank configured to receive an unscreened partial flow of the suspension from the pulper and a pump apparatus;
a screen apparatus comprising:
an retaining area configured to retain the contaminants accumulated therein,
a screen configured to screen the partial flow of the suspension, and
a discharge area configured to discharge the contaminants from the screen apparatus continuously or at adjustable intervals, wherein
the pump apparatus is configured to pump the unscreened partial flow of the suspension into the screen apparatus and recirculate a recirculation flow of the unscreened partial flow into the settling apparatus from a pressure line of the pump apparatus.

20. The system according to claim 19, wherein the screen is a flat screen which is kept clear by a central rotor.

21. The system according to claim 19, wherein the recirculation flow is divided off from the pressure line at a point that is a maximum of about 2 m from an infeed into the screen apparatus.

22. The system according to claim 19, wherein the recirculation flow is divided off from the pressure line at a point that is a maximum of 1 m from the infeed into the screen apparatus.

23. The system according to claim 19, wherein the screen apparatus is operated with a perpendicular axis and an accepted stock chamber is arranged above the screen.

24. The system according to claim 19, further comprising a screening device at least about 3 m higher than the screen apparatus.
